(19) United States
(12) Patent Application Publication
(10) Pub. No.: US 2008/0103270 A1
(43) Pub. Date: May 1, 2008

(54) Core/Shell Type Polyamine Dendrimer Compound

(76) Inventors: Isao Sato, Kanagawa (JP); Toru Inaoka, Kanagawa (JP); Seiichi Suzuki, Kanagawa (JP); Hayato Itagaki, Kanagawa (JP); Yoshiyuki Onda, Tokyo (JP)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 10/529,964

(22) PCT Filed: Oct. 2, 2003
(86) PCT No.: PCT/JP03/12649

§ 371 Date: Dec. 10, 2007

(30) Foreign Application Priority Data
Oct. 2, 2002 (JP) 2002-290275

(51) Int. Cl. C08F 283/00

(52) U.S. Cl. 525/540

(57) ABSTRACT

A core/shell type polyamine dendrimer compound comprising core regions formed of a dendrimer compound and shell regions formed by the reaction of at least one amine compound. A method for the production of the compound is also disclosed.

### TECHNICAL FIELD

This invention relates to a core/shell type polyamine dendrimer compound in which a core region has no amine as a main component and a shell region has an amine as a main component. The compound according to this invention is enabled to ensure effective utilization of the amino group therein by causing the amino group incorporated in the molecular skeleton thereof to be exposed as much as possible through the molecular surface thereof without being buried in the polymer molecule. The compound is rendered particularly suitable for application as a drainage agent in the field of paper industry and as an anionic component. coagulating agent like a sludge coagulating agent in the field of waste water treatment.

### BACKGROUND ART

In the industrial field in which anionic components are coagulated and separated from the effluent or slurry emanating from the paper plant or the waste water disposal, cationic polymers such as quaternary ammonium-containing polymer compounds and polyamine compounds are useful as additives. Generally, they excel in the ability to coagulate anions and the ability to remove water from the aggregate in proportion as the amine density of polymer is increased or the molecular weight thereof is heightened.

The polyalkylene imines are utilized as typical cationic polymers in numerous industrial fields. Among them, the polyethylene imine has an extremely high amine density such as 23.3 m.mols/g. The polyethylene imine is highly useful as various coagulating agents because it produces a comparatively low deleterious effect in handling and manifests high solubility in water and other various polar solvents. The polyethylene imine that is commercially available assumes a highly branched structure by reason of the process of manufacture though the straight-chain polyethylene imine can be prepared academically by hydrolyzing polyoxazoline. In a low/medium molecular weight polyethylene imine having a molecular weight on the order of several hundreds—some tends of thousands, for example, the primary/secondary/tertiary amine ratio is roughly 36/36/28 depending on the molecular weights thereof. From the proportion of the presence of the tertiary amine, it may be inferred that such a polyethylene imine has a high degree of branched structure. In the light of this structural factor, part of the amino groups incorporated in the molecular skeleton which are positioned in the proximity of the center of the structure would be in such a position as renders difficult the contact there of with other neighboring molecules. In fact, when the polyethylene imine is assayed for the amine content by the popular nonaqueous titration, the amino group that is equivalent to 80-95% of the theoretical value can be measured. Thus, the polyethylene imine might be added in an amount not less than the equivalent weight of the amine, which is actually necessary, in the actual papermaking process.

In contrast, a polymer molecule design that the amino groups in the structure are easily contacted with another molecules in the surroundings has been proposed. Scharf et al. have reported a method for producing a polyamine compound by grafting ethylene imine to the polyamide amine obtained by the condensation reaction of diethylene triamine with adipic acid, cross-linking the resultant product with a polyethylene glycol wherein both terminals thereof are modified with epichlorohydrin, and further neutralizing the resultant cross-linked with formic acid (JP-B-57-5813). The polyamine compound thus prepared has a structure in which the polyethylene imine chains are dispersed to a greater degree than those of the polyethylene imine homopolymer, so that the amine groups therein are easily utilized effectively. This polyamine compound has been confirmed to be available as a drainage agent or as a retention agent in the papermaking.

In the design of the molecular model that is allowed for the amino groups to function effectively, however, there is room for further improvements.

Several molecular forms have been proposed such as dendrimer compounds with a regular multiply branched structure and core/shell type compounds with a binary structure having different main components inside/outside the molecule, which differ from the conventional straight-chain molecular form, as polymer compounds which are advantageously usable in various industrial fields like papermaking, paper coating, electronic/optical materials, and biopharmaceutical preparations.

Denkewater et al. have reported synthesis of a polylycine dendrimer as examples of a dendrimer compound (U.S. Pat. No. 4,289,872). Tomalia et al. have reported numerous dendrimer compounds such as a polyamide amine dendrimer (U.S. Pat. No. 4,435,548) resulting from the repeated reaction of a diamine compound with a carboxylic ester, and a cylindrically shaped dendrimer (JP-B-8-2960) resulting from modifying a straight-chain polyamine to apolyamide amine. Daroux et al. have reported a dendrimer type polymer electrolyte (JP-A-8-69817) resulting from adding an ethylene oxide to analkoxylatedpolyethylene imine. Allen et al. have reported a paper making grade dendrimer type polymer (JP-A-2002-501582) resulting from branching a diamine compound by sequential addition of acrylonitrile/hydrogen thereto and then grafting propylene imine to the resulting product.

Wooley et al. have reported medicinal particles as examples of a core/shell type compound (JP-A-2001-508762) formed of an amphipathic copolymer with a hydrophilic cross-linked shell region and a hydrophobic inner core region. Aoi et al. have reported a compound (Aoi et al.: Tetrahedron, 53, 15415 (1977)) resulting from the reaction of a polypropylene imine with sarcosine N-carboxy anhydride as a core compound, and a compound (Aoi et al.: Macromolecules, 28, 5391 (1995)) resulting from the reaction of a polyamide amine dendrimer with lactonolactone as a core compound. These are radial core/shell type dendrimer compounds in which the dendrimer compound is used as the core region and a specific atomic group is set up on the surface of the dendrimer compound, and useful molecular designs directed toward effectively manifesting a target function.

No sufficient study, however, has yet been given to the core/shell type polyamine dendrimer compounds, which are furnished with a core region formed of a dendrimer compound having no amine as a main component and a shell region having an amine as a main component, and which are intended to have amino groups so set up spatially as to function effectively without being buried in the molecule.

### DISCLOSURE OF THE INVENTION

An object of this invention is to provide a novel polyamine compound with a core-shell type dendrimer structure, and a method for the production thereof. This compound is expected to function effectively as a coagulant for an anionic component, as compared with the well-known compound. The compound according to this invention excels in the drainage or retention ability even at a comparatively small application ratio, for example, as the additive in the process for the production of paper.

This invention concerns a core/shell type polyamine dendrimer compound, characterized by having a core region formed of a dendrimer compound (I) and a shell region formed by the reaction of an amine compound (A) with the dendrimer compound (I) mentioned above.

This invention further concerns a method for producing a core-shell type polyamine dendrimer compound, characterized by forming a core region by using a dendrimer compound (I) and forming a shell region by causing an amine compound (A) to react with the dendrimer compound (I) mentioned above.

### BRIEF DESCRIPTION OF THE DRAWINGS

FIG. 1 is a schematic diagram depicting the cross-sectional structure of a star type dendrimer.

FIG. 2 is a schematic diagram depicting the cross-sectional structure of a star burst type dendrimer.

FIG. 3 is a schematic diagram depicting the cross-sectional structure of another star type dendrimer.

FIG. 4 is a schematic diagram depicting the cross-sectional structure of yet another star type dendrimer.

### BEST MODE FOR CARRYING OUT THE INVENTION

The major terms, which are used in the present description, will be defined as follows.

Polymer: A large molecule formed by the repeated combination of chemical units of one or several kinds. The molecule has straight-chain structures, as well as branched structures and three-dimensional network structures.

Branched polymer: A polymer having branched chains intermittently joined to the straight-chain type skeleton.

Bifurcation point: The part of a branched polymer which includes an atom at which three or more polymer chains are joined.

Starting substance: A compound which forms the source for the reaction of a chain extending agent or a branching agent in a branched polymer.

Branching agent: A reactive compound to be used for branching by allowing it to react with part of the straight-chain molecular chains, mainly the terminals thereof in a branched polymer. It is used as part of a structure organizer, since it is not expected to fulfill any particular function besides the branching of molecular chains.

Chain extending agent: A reactive compound to be used in a branched polymer for the purpose of extending molecular chains in the shape of a straight chain. It is used as part of a structure organizer, since it is not expected to fulfill any particular function besides the extending of molecular chains.

Modifier for amine reacting terminal functional group: A reactive compound which serves to modify a compound, which forms a core region, into a molecular form with at the terminals of a molecular chain functional groups capable of reacting with amine compounds, by allowing it to react with the terminals of molecular chains incapable per se of reacting with an amine compound.

Arm: The straight-chain part of a branched polymer which is joined to the most end of bifurcation point and extended radially from the most end to the terminal of a molecule.

Dendrimer: A branched polymer compound with a multiplicity of polymer arms extending radially from the central part of a molecule.

Star type dendrimer: A dendrimer, which is estimated from the process of production thereof, to have multiply divided and branched parts that are locally collected at the central part of the polymer molecule and have arms extended to a comparatively long length from the final bifurcation point.

Star burst type dendrimer: A dendrimer, which is estimated from the process of production thereof, to have multiply divided and branched parts that are not locally collected at the central part of the polymer molecule but rather spread and have arms extended to a comparatively short length from the final bifurcation point.

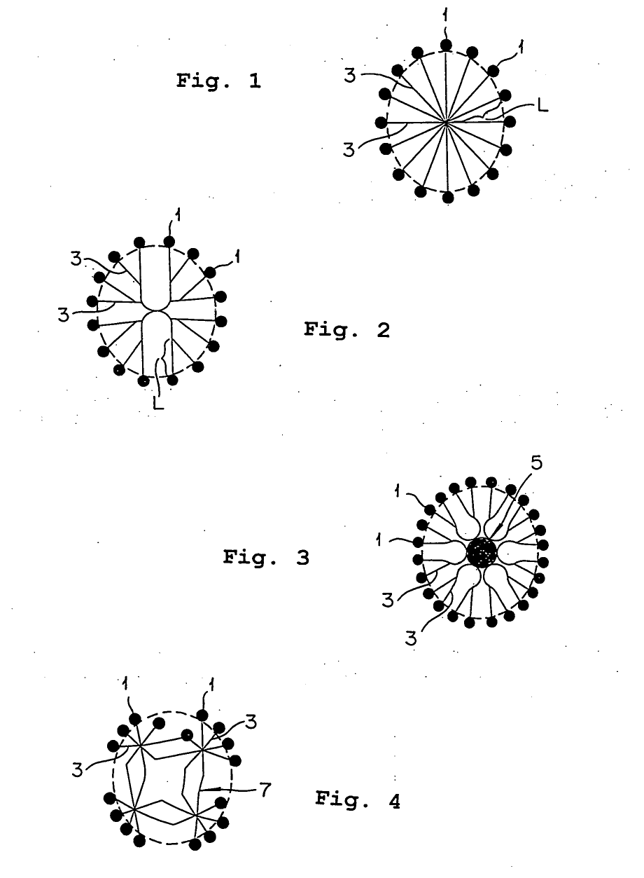

The dendrimer contemplated by this invention is defined as a branched polymer compound in which at least three polymer arms, joined to the branched body, which forms the central part of the dendrimer, are radially extended. FIGS. 1-4 illustrate structural drawings of the dendrimers.

FIG. 1 is a cross-sectional schematic drawing of a star type dendrimer. A dendrimer compound that forms a coreregion is formed of a central branched part and straight-chain arm parts extending from the final bifurcation point to the terminals. The structure of this dendrimer is such that the proportion of the size of the central branched part to the whole of the molecule is comparatively small and the length of the straight-chain arm parts extending from the final bifurcation point to the terminals is comparatively long. The central branched part may be formed of either a single starting substance that has in the molecular unit thereof at least three reactive functional groups able to be reacted by a chain extending agent or a synthetic compound obtained by subjecting a starting substance, as occasion demands, to a reaction with a branching agent and a chain extending agent thereby producing multiple branches. In FIG. 1, the solid lines 3 represent regions having no amine as a main component, the black circles 1 represent regions having an amine as a main component, and L represents the length of arm. This notation similarly applies to FIGS. 2-4.

FIG. 2 is a cross-sectional schematic drawing of a star burst type dendrimer. The dendrimer compound that forms a core region has such a structure that the proportion of the size of the central branched part to the whole of the molecule is comparatively large and the length of the straight-chain arm parts extending from the final bifurcation point to the terminals is comparatively short, since the branching is produced relatively uniformly from the center of the molecule to the terminals. The central branched part is made of a synthetic compound obtained by subjecting a starting substance, as occasion demands, to the reaction with a branching agent and a chain extending agent thereby producing multiple branches.

FIG. 3 is a cross-sectional schematic drawing of a star type dendrimer, in which the central branched parts of the dendrimer compound, which forms core regions, partly includes a high amine density portion. This inclusion occurs when a compound of a high amine density is used under specific circumstances as one of the starting substance, branching agent, or chain extending agent which form the central branched part. The amine in the core region is not expected to contribute in terms of function. It is, however, thought that the amine density in the core regions is comparatively low on the average, and that the amine incorporated into the molecular skeleton is utilized effectively as compared with the polyamines that are not in the core/shell type.

FIG. 4 is another cross-sectional schematic drawing of a star type dendrimer, in which the core regions are formed of a crosslinked polymer of a plurality of dendrimer type compounds. When a dendrimer compound is synthesized from a single starting substance solely by the reaction of a chain extending agent without using a branching agent, the dendrimer compound cannot be synthesized to an appreciably high molecular weight because of the limitation of the molecular weight per arm, which will be described herein below. The reason for this limitation is that so numerous functional groups, as are desired, cannot actually exist, notwithstanding the assertion that a plurality of functional groups capable of reacting with the chain extending agent are contained. In this case, the dendrimer compound or a terminal-modified dendrimer compound formed with an amine-reacting terminal functional group modifying agent must be cross-linked using a cross-linking agent 7 till it acquires a prescribed high molecular weight. By this method, it is possible to prepare a macromolecular substance, which forms core regions, in spite of the limitation on the molecular weight per molecular chain.

Now, the core/shell type polyamine dendrimer compound according to this invention and the method for the production thereof will be described below.

### (Dendrimer Compound)

The core/shell type polyamine dendrimer compound contemplated by this invention can be produced by forming core regions by using a dendrimer compound (I) and causing an amine compound (A) to react with the dendrimer compound (I) mentioned above. The core/shell type polyamine dendrimer compound is preferably produced by allowing a dendrimer compound (i) with active hydrogen to react with a modifying agent for amine reacting terminal functional group (B) with a functional group capable of reacting with the active hydrogen of the dendrimer compound (i) and a separate functional group capable of reacting with the amine compound (A) thereby forming core regions by using the dendrimer compound (I) in which part and/or the whole of the active hydrogen of the dendrimer compound (i) mentioned above is modified, and forming shell regions by causing the dendrimer compound (I) to react with an amine compound (A).

The term “dendrimer” as used herein means the form of a compound, and is derived from the Greek word “dendra” that means trees. This compound assumes a structure in which a plenty of branched molecular chains radially extend from the central part of the molecule. Owing to this branched structure, the spatial expanse of the dendrimer compound is comparatively small for the molecular weight thereof and it generally approximate spheres measuring up to several hundreds of Å in diameter. The dendrimer compound is capable of molecular design independently of for example core, branched chains, surface, and is able to attain a three-dimensional molecular structure, as compared with the conventional straight-chain type polymer compound. The compound can be expected to have the function thereof markedly enhanced by having specific atomic groups effectively set up spatially so as to suit the purpose of use. It will be applied in a wide range of fields covering nano-capsules, gene-transferring vectors, liquid crystals, and electronic/optical materials.

Branched polymer compounds such as polyethylene imine and polypropylene imine, which are commercially available, are dendrimer compounds of one kind. They are formed by the polymerization of a reactive monomer whose branch is spontaneously promoted. The method for synthesizing a dendrimer compound based on the molecular design directed toward manifesting an objective function includes two types, i.e. the divergent method and the convergent method. The divergent method comprises repeating stepwise reactions on a starting substance destined to form the center of the compound thereby growing branches. In contrast, the convergent method comprises synthesizing a dendron conversely stepwise from a marginal structural part and finally uniting a plurality of dendrons.

The dendrimer compound to be used in this invention is not particularly restricted but only required to have the structure of a dendrimer, for example, a dendrimer structure formed of a central branched part including at least one bifurcation point and straight-chain arm parts that are joined to the most end of bifurcation point and radially extended from the most end of bifurcation point to the terminals of the molecule, the number of the arms being at least three per molecule, or a structure resulting from cross-linking the dendrimer structure mentioned above.

The number of arms in the core regions of the polyamine dendrimer compound is generally in the range of 3-500 pieces and preferably in the range of 10-200 pieces. If the number of arms is small, the amount of amino groups necessary for the total amount of a molecule will be reduced unless the amount of amine to be provided per arm is increased. In order to increase the amount of amine to be provided per arm, it is essential not to increase the proportion of amine, inherently contained in the shell regions and nevertheless suffered to bury therein. If this number exceeds 500, the excess will not provide superiority in terms of function.

The molecular weight of the polyamine dendrimer compound per arm in the core regions is generally not more than 10,000. If it exceeds 10,000, the viscosity of the synthesized compound will reach a very high level exceeding 10,000 mPa.s even at a high temperature of 130° C. As a result, the operation of stirring in the bulk synthesis will become difficult or the synthesis reaction will necessitate use of an inert solvent incapable of adversely effecting the reaction.

The dendrimer compound described above exhibits the following properties.

(1) “The ratio, M/<S²>^{1/2}, of the weight average molecular weight, M, to the inertia square radius, <S²>^{1/2}, determined of a dendrimer compound by the static light scattering method, is not less than 100”

The M and <S²>^{1/2} in the above formula are determined by the Zimm plot or the Berry plot of the results of analysis. In an ordinary straight-chain compound, the correlativity of fluctuation ought to exist between M and <S²>^{1/2}. That is, the ratio , M/<S²>^{1/2}, cannot be fixed but falls substantially in a prescribed range because a polymeric compound is thought to have the molecular radius thereof increase in proportion as the molecular weight thereof grows. Let us assume a compound that has core regions formed of a polyethylene glycol dendrimer, for example. When a branched polyethylene glycol having a theoretical molecular weight of 1,000,000 and a branched degree of 160 was analyzed by the static light scatting method, M was found to be 9.18×10⁵ and <S²>^{1/2} to be 347 Å. Thus, M/<S²>^{1/2} amounted to 9.18×10⁵/347=2.7×10³. In the case of a straight-chain polyethylene glycol having a theoretical molecular weight of 13,000, M was found to be 2.33×10⁴ and <S²>^{1/2} to be 822 Å. Thus, M/<S²>^{1/2} amounted to 2.33×10⁴/822=29. Thus, the ratio, M/<S²>^{1/2}, of the dendrimer type compound assumes a very high value, as compared with that of the straight-chain type compound, because the dendrimer type compound has a small molecular radius for the molecular weight. This fact indicates that the dendrimer type compound assumes such a molecular form as exhibits a small spatial expanse for the molecular weight owing to the multiply branched structure. These results establish that the compound contemplated by this invention assumes a highly branched dendrimer structure.

(2) “The ratio, M/M′, of the weight average molecular weight M of a dendrimer compound determined by the static light scattering method to the number average molecular weight M′ calculated from the measured value of valency of terminal functional groups, is less than 1.”

The M′ as used herein can be found by analyzing the terminal functional group value of a compound, which forms core regions, so as to compute the average molecular weight per molecule chain and further multiplying this molecular weight by the theoretical degree of branches. The terminal functional group value can be determined by the method of titration performed under specific conditions, which fit the kind of relevant functional groups. The theoretical branched degree is self-evident from the kind of a starting substance used and the amount of a branching agent used. Let us assume a compound that has polyethylene glycol dendrimer for core regions thereof, for example. When a branched polyethylene glycol having a theoretical molecular weight of 1,000,000 and a branched degree of 160 was analyzed by the static light scattering method, M was found to be 9.18×10⁵ as mentioned above. Then, the terminal hydroxyl value, HV, was found to be 9.2 (mg KOH/g) by the method for determining the hydroxyl value by titrating with potassium hydroxide the acetic acid generated during acetylation with acetic anhydride. The molecular weight per hydroxyl group, i.e. the average molecular weight per molecular chain, therefore, ought to be found to be 1/(9.2×10⁻³/56.1)=6.10×10³ (g/mol of hydroxyl group). In consequence of the multiplication by this theoretical branched degree, M′ is found to be 6.10×10³×160=9.76×10⁵. The ratio M/M′, therefore, turns out to be 9.18×10⁵/9.76×10⁵=0.94. In the case of a straight-chain type polyethylene glycol having a theoretical molecular weight of 13000, M was found to be 2.33×10⁴, HV to be 8.5 (mg KOH/g), and consequently M′ to be 1.32×10⁴. The ratio M/M′, therefore, ought to turn out to be 2.33×10⁴/1.32×10⁴=1.77. The M/M′ ratio of a dendrimer type compound assumes a rather low value as compared with that of a straight-chain type compound, because the dendrimer type compound has a small molecular radius for the molecular weight as described above. This fact indicates that the dendrimer type assumes such a molecular form as manifests a small spatial expanse because of the multiply branched structure.

(3) “The ratio M″/M′, of the weight average molecular weight M″ of a dendrimer compound determined by the method of gel permeation chromatography (GPC) to the number average molecular weight M′ computed from the measured value terminal functional group value, is less than 0.9.”

The M″ as used herein is found simply and easily by the GPC analysis performed under conditions such as fit the kind of compound destined to form core regions. In the GPC analysis for a fixed kind of compound, the elution speed is increased proportionately to the molecular weight in accordance with the elution volume. However, the elution speed of a dendrimer type compound is low as compared with that of a straight-chain type compound because of a small spatial expanse, and the M″ is found by the determination to be rather smaller than actual. Let us assume a compound that has polyethylene glycol dendrimer for core regions, for example. A branched polyethylene glycol having a theoretical molecular weight of 1,000,000 and a branched degree of 160 was subjected to the GPC analysis using Shodex OHpak SB-802HQ, SB-803HQ, SB-804HQ, and SB-805HQ (available from Showa Denko K. K.) as columns, water as an eluant, and a straight-chain type polyethylene glycol as a reference material. As a result, M″ was found to be 3.54×10⁵. Since M′ was 9.76×10⁵ as mentioned above, the ratio M″/M′ turns out to be 3.54×10⁵/9.76×10⁵=0.36. In the case of a straight-chain polyethylene glycol having a molecular weight of 13,000, since M″ was found to be 1.58×10⁴ and M′ was 1.32×10⁴ as mentioned above, the ratio M″/M′ ought to turn out to be 1.58×10⁴/1.32×10⁴=1.20. Since the dendrimer type thus has a small molecular radius for the molecular weight, the M″/M′ ratio thereof is a very low value as compared with the straight-chain type. This fact indicates that the dendrimer type assumes such a molecular form as manifests a small spatial expanse because of the multiply branched structure.

The analysis conditions in the static light scattering method and the GPC method can be arbitrarily set at the conditions that are most suitable for the analysis of a target compound fated to form core regions. The measured values must be handled with care, since the values change depending upon the kind of solvent used. The solvent to be applied is restricted to that capable of dissolving the target compound, and the solvent having a good solubility is preferable. Particularly, the solvent is preferred to manifest solubility of not less than 100 (mg/ml) to the target compound destined to form core regions. Water, and methanol, for example, are preferred solvents for polyethylene glycol dendrimers.

The dendrimer compound mentioned above can be produced by sequentially or simultaneously adding a starting substance formed of a compound with at least one active hydrogen atom in the molecular unit thereof, a branching agent (C) that can be modified to a molecular form having less than two active hydrogen atoms newly by the reaction of an active hydrogen atom, and a chain extending agent (D) capable of growing molecular chains while leaving behind at least one active hydrogen atom at the terminal through a continuous addition reaction to the active hydrogen atoms and allowing them to react with one another.

Examples of the starting substance to be used for forming core regions are compounds which have within one molecule thereof not less than three reactive functional groups capable of reacting with a chain extending agent in the case of using a chain extending agent without using a branching agent or compounds which have within one molecule thereof at least one functional group capable of reacting with a branching agent or a chain extending agent in the case of attempting the branch at a later stage owing to the use of a branching agent. Concrete examples of such compounds may include polyhydric alcohols such as ethylene glycol and diethylene glycol; polysaccharides such as sorbitol; polyvalent carboxylic acids such as citric acid; and polyvalent amines such as ethylene diamine and diethylene triamine. Further, various commercially available polymer compounds having not less than three active hydrogen atoms are useful. Among them, polyhydric alcohols prove particularly preferable from the viewpoint of inexpensive, and the ease of getting and handling.

Branching agent to be used for forming core regions are not particularly restricted but may include a compound capable of producing not less than two active hydrogen atoms through the reaction with the functional group at the terminal of an arm part or a compound having a functional group capable of reacting with the functional group at the terminal of an arm part and a separate reactive functional group in combination with a compound acquiring within the molecule thereof not less than two active hydrogen atoms through the reaction with the functional group capable of reacting with the separate reactive functional group mentioned above. Concrete examples of the branching agent may include glycidols capable of investing two hydroxyl groups by the addition of one molecule through the ring-opening addition reaction of an epoxy group. As the branching agent, glycidol proves preferable because it excels in reactivity with active hydrogen and because an excess by-product, arising from the reaction of an inorganic salt does not remain.

Examples of the chain extending agent to be used for forming core regions may include alkylene oxides such as ethylene oxide and propylene oxide in view of inexpensive. Ethylene sulfide is also usable. Alkylene imines such as ethylene imine and propylene imine are partly usable as a combination of branching agent and chain extending agent at the central part, though they are not safely called as advantageous applications because the amino group is buried in the dendrimer molecules. As the chain extending agent, alkylene oxides prove particularly advantageous because they are comparatively inexpensive and manifest only a low deleterious effect. The alkylene oxides mentioned here are represented by the following formula.

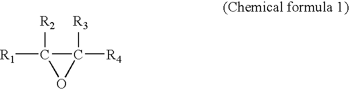

wherein R₁-R₄ independently denote an alkyl group of 1-4 carbon atoms or a hydrogen atom.

Specifically, the reaction is performed as follows.

A pressure vessel such as an autoclave is charged with a starting substance and a catalyst and heated together therewith to an elevated temperature for example in the range of 120°-130° C. Then, the initially charged liquid is dehydrated by decompressing the interior of the vessel and stirring the raw material liquid. Subsequently, the vessel is filled to capacity with an inert gas such as nitrogen gas so as to maintain the pressure in the system engaging in the reaction at a stated pressure, for example, 50 kPa, necessary to maintain the pressure within a safe range. To the system, a branching agent such as glycidol and a chain extending agent such as an alkylene oxide are gradually injected. The molar ratio of amounts of the glycidol and the alkylene oxide to be injected can be arbitrarily set in accordance with the molecule model expected to be designed. When the molar ratio of amount of the glycidyl to that of the alkylene oxide is small, a multiply branched structure will be approached because the linear units of the molecular chains are short. Adversely, when this molar ratio is large, few branched structure will be approached because the linear units are long. The molar ratio is preferred to be in the range of 1-50 for the purpose of synthesizing a dendrimer compound branched to a high degree for forming a multiply branched central part of a star type dendrimer. Otherwise, the molar ratio is preferred to be in the range of 100-200 for the purpose of synthesizing a star burst type dendrimer branched averagely from the central part through the marginal part. The reaction is continued at 130°-150° C. for 4-6 hours while the heat generated in the reaction is continuously removed. Then, the dendrimer compound having a prescribed molecular weight can be produced by repeating up to several rounds a process of injecting the branching agent and the chain extending agent by way of replenishing the intermediate of synthesis, for the convenience of the scale of reaction and the balance of raw materials for charging. Though the number of repetitions is not particularly restricted because it is decided in accordance with the molecular weight of the objective product, the scale of the reaction, and the balance of raw materials for charging. It is generally not less than two and preferably in the range of 3-7.

### (Modification with a Modifying Agent for Amine Reacting Terminal Functional Group)

It becomes necessary to have part and/or the whole of the arm terminal of the dendrimer compound modified prior to the reaction of the compound with an amine compound, in the case that the amine compound cannot be directly reacted therewith under the ordinary conditions in the reaction of the amine compound at a later stage, in view of the properties of the terminal functional group of a dendrimer compound, which forms core regions.

Examples of the functional group that is added in advance to the arm terminal of a compound, which forms core regions by the reaction of modification may include an aldehyde group; a carbonyl group; halogen groups such as chlorine group and bromine group; an isocyanate group; an alkenyl groups; an epoxy group; a carboxyl group; carboxylic ester group; carboxylic halides; carbamic acid; and carboxylic anhydride. Any functional group other than those just enumerated is not particularly restricted so long as it exhibits reactivity with an amine compound.

The compound to be used as a modifying agent for an amine reacting terminal functional group, therefore, preferably comprises a compound with in the molecule thereof both a first functional group capable of reacting with the arm terminal of an unmodified compound, which forms core regions, and any of second amine reacting functional groups mentioned above or a compound with in the molecule thereof both the first functional group and a separate third reactive functional group in combination with a compound with in the molecule thereof a fourth reactive functional group capable of reacting with the third reactive functional group and the second amine reacting functional group. Examples of the modifying agent for the amine reacting terminal functional group which is useful for a dendrimer compound with a hydroxyl group at the terminal thereof may include epichlorohydrin (the epoxy group thereof reacting with a hydroxyl group and, at a later stage, the chloro group reacting with amine), allylglycidyl ether (the glycidyl group reacting with a hydroxyl group and, at a later stage, the allyl group reacting with amine), 2-chloroethyl isocyanate (the isocyanate group reacting with a hydroxyl group and, at a later stage, the chloro group reacting with amine), acetic anhydride (the ring-opening reaction occurring on a hydroxyl group and, at a later stage, the carboxyl group reacting with amine), sodium hydride used in combination with allyl chloride (the sodium hydride reacting with a hydroxyl group (with elimination of water) and, after (the elimination of water), the terminal sodium reacting with allyl chloride (with elimination of sodium chloride) and, at a later stage, the allyl group reacting with amine), and sodium hydride used in combination with chloro-acetic acid (the sodium hydride reacting with a hydroxyl group (with elimination of water) and subsequently the terminal sodium reacting with chloro-acetic acid (with elimination of sodium chloride) and, at a later stage, the carboxyl group reacting with amine).

Specifically, the reaction is performed as follows.

A dendrimer compound as the raw material and a solvent such as dioxane are mixed and subsequently heated together to an elevated temperature for example in the range of 60°-100° C. The gas in the reaction system is displaced with an inert gas such as nitrogen. At the same temperature, after the addition of a catalyst such as BF₃·OEt₂ the mixture is stirred for instance for 15 minutes—one hour. Thereafter, epichlorohydrin is dissolved in the solvent mentioned above and then gradually introduced into the reaction system. The molar ratio of the amount of epichlorohydrin so introduced to the amount of the terminal functional group may be set at an arbitrary level, depending on the objective form of provision of amine. The molar ratio mentioned above is set at 1 in the case of provision of amine for all the arm terminals in order to effectively utilize the branched structure of a dendrimer compound to the fullest possible extent. The molar ratio is arbitrarily set in the range of 0.01—less than 1 in the case of provision of amine for part of the arm terminals. After the introduction of the solution, the temperature of the reaction system is further maintained for instance for 2 to 4 hours. The content of the reaction system, as occasion demands, is concentrated under a reduced pressure so as to expel the solvent, the unaltered epichlorohydrin, and the by-product therefrom.

### (Reaction of Amine Compound)

In preparing a dendrimer compound, which forms core regions, for direct reaction with an amine compound, special reaction conditions such as temperature, pressure, and kind of catalyst must be so set as to suit the reactivity of the terminal functional group of the dendrimer compound with the amine compound. A method for causing ammonia to react with the terminal hydroxyl group of a polyalkylene glycol in the presence of a mixed catalyst, which includes the oxides of nickel, copper, and chromium previously reduced, under the conditions of high temperature and high pressure has been known as an example for modifying the terminal amine of a polyalkylene glycol without using an amine reacting terminal functional group modifying agent (U.S. Pat. No. 3,654,370).

The dendrimer compound, which forms core regions, is allowed to react with an amine compound (A), after the modification of the terminal functional group, to form shell regions.

In this case, the number of amino groups per molecule of the modifying amine compound for forming the shell regions is generally in the range of 1-500 pieces. Naturally, if the number of amino groups is small, the number of amino groups necessary for the whole molecule is no longer fulfilled depending on the degree of branch. If the number of amino groups exceeds 500, the proportion of the amine buried in the shell regions to that even contained within the shell regions will grow.

The molecular weight of the modifying amine compound for forming the shell regions is generally in the range of 17-100,000 and preferably in the range of 17-20,000. Ammonia, which has a molecular weight of 17, constitutes the compound of the lowest molecular weight as the amine modifying compound. If the molecular weight exceeds 100,000, the proportion of the amine buried within the shell regions will be increased.

The modifying amine compound for forming the shell regions is not particularly restricted, but only required to be a compound with not less than one amino group in the molecular skeleton. Examples of the modifying amine compound may include inorganic amines such as ammonia; alkyl amines such as ethylene diamine and diethylene triamine; alkylene imines such as ethylene imine and propylene imine; polyalkylene imines; and macromolecular polyamines such as polyvinyl amine and polyallyl amine. Among them, alkylene imines and polyalkylene imines are usable particularly advantageously. Especially, ethylene imine and polyethylene imine allow formation of shell regions having a very high amine density.

The alkylene imines are represented by the following formula.

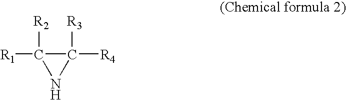

wherein R₁-R₄ independently denote an alkyl group of 1-4 carbon atoms or a hydrogen atom.

Then, the polyalkylene imines are represented by the following formula.

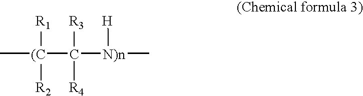

wherein R₁-R₄ independently denote an alkyl group of 1-4 carbon atoms or a hydrogen atom and n denotes an integer in the range of 7-500.

Specifically, the reaction is performed as follows.

An amine compound and a solvent such as water are thoroughly stirred. The concentration of the amine compound is set arbitrarily in the range of 1-100%, according to the solubility of the amine compound with the solvent and the viscosity of the solution. Then, the resultant mixture is heated to for example 60°-100° C. and allowed to react therewith for instance for 1-3 hours while gradually adding a dendrimer compound modified with an amine. The molar ratio of the amount of the terminal functional group in the introduced dendrimer compound to that of the amine compound can be set arbitrarily, depending on the objective form of provision of amine. The molar ratio mentioned above is set at 1 in the case of provision of amine for all the arm terminals in order to effectively utilize the branched structure of a dendrimer compound to the fullest possible extent. The molar ratio is arbitrarily set in the range of 0.01—less than 1 in the case of provision of amine for part of the arm terminals. When an amine compound that has a plurality of amino group active hydrogen atoms in the molecule thereof is adopted as the amine compound, however, the reaction progresses in the excess of amino group and tends to entail an intermolecular cross-linking reaction even when the molar ratio is less than 1, because all the dendrimer compound terminals do not receive amines evenly and a plurality of molecules of dendrimer compound terminal functional groups are suffered to react with each of the molecules of the amine compound. One possible approach to the repression of this adverse effect may reside in setting the molar ratio mentioned above at a low level in the approximate range of 0.01-0.2 and expelling the excess unaltered amine compound from the system as by chromatographic collection. After the addition is completed, the temperature is further maintained for instance for 0.5-2 hours. Thereafter, the reaction product is cooled to room temperature.

### (Core/Shell Type Polyamine Dendrimer Compound)

The core-shell type polyamine dendrimer compound is thus obtained.

In this case, what is obtained is not the core-shell type polyamine dendrimer compound itself but is the aqueous solution thereof. It is convenient to obtain the compound in the form of an aqueous solution for the sake of handling, since the compound is generally synthesized in the form of a high molecular substance having a molecular weight on the level ranging from some hundred thousand through millions on account of the purpose of use. If the core/shell type polyamine dendrimer compound itself is required to be separated or recovered in an extremely concentrated state, the recovery will be attained by being thoroughly dehydrated at a high temperature in the range of 120°-200° C. under a reduced pressure in the range of 3.8-15.0 hPa, for example, depending on the molecular weight of the objective compound.

The core-shell type polyamine dendrimer compound of the present invention exhibits the following properties.

(i) “The ratio, AVn/AVc, of the amine numberAvn (unit: m.mols/g-solid, amount of amino groups in m.mols per g of solid) determined by nonaqueous titration to the theoretical amine number AVc determined by colloidal titration, is in the range of 0.8-1.0.”

For the determination of amine by titration with an acid, the assay of nonaqueous titration is useful which determines the amine content of a sample based on the change in potential difference due to the reaction with a strong acid in an acidic organic solvent. Generally an amine compound is slow to show a change of pH in response to the reaction thereof with an acid and thus the pH titration of the amine compound in an aqueous solution, therefore, generates no easily discernible inflection point. Adversely, the nonaqueous titration allows comparatively clear discernment of a reaction equivalent point with an acid.

According to colloidal titration, an aqueous polyamine compound diluted with water to an extremely low level is cationized with an acid, and the amine content is determined by the formation of colloid with an anionic polymer. It is possible to perform the determination of amine with extremely high accuracy by adjusting the pH value of the aqueous solution to strong acidity of not more than 2 and promoting the reaction between cationic charges, for the amine polymers with a molecular weight of not less than several hundreds.

The AVn/AVc ratio is in the approximate range of 0.80-0.95 for a polyethylene imine homopolymer that has the amino group distributed evenly from the inner part to the marginal part of the molecule, even if it is branched to a high degree similarly to the core-shell type polyamine dendrimer compound obtained by this invention. It has been confirmed that the magnitude of this ratio tends to decrease in accordance as the molecular weight used increases. It is considered in the compounds which are branched to a high degree that the ordinary nonaqueous titration is incapable of determining fully the amino group buried within the molecule. The fact that the AVn/AVc ratio falls short of 0.80 can be easily inferred in the case of a high molecular branched polyamine compound having a molecular weight exceeding 100,000. In the compound contemplated by this invention, however, the AVn/AVc ratio is of not less than 0.80. This value never falls short of 0.80 in the present compound depending on the dendrimer structure for forming core regions, the kind of an amine compound to be used for modification, the rate of reaction, and the molecular weight of the product. This endorses the fact that the amino group provided is spatially so arranged as to be exposed through the periphery of the molecule without being buried within the high molecular substance.

(ii) “The viscosity is comparatively low for the molecular weight and fit to facilitate the production and handling of the high molecular substance.”

The core/shell type polyamine dendrimer compound of this invention has comparatively low viscosity as compared with the other polymer compounds that have molecular weights on an equal level. This low viscosity may be ascribed to the fact that the surface area of the compound is small for the molecular weight on account of the structure peculiar to a dendrimer, and the effects of the physical tangling of the molecule with adjacent molecules and of the chemical interaction of the compounds are comparatively small, because the compound acquires a structure closely to a sphere as compared with a linear molecule. These properties are advantageous in handling the compounds during and after the production.

The core/shell type polyamine dendrimer compound obtained by this invention has “the form having a plurality of amine compounds imparted to the periphery of either a dendrimer compound for forming a core or the cross-linked body thereof” as the definition of one molecule. Though the structure is complicated, the molecular weight thereof can be determined by the static light scattering method, for example.

The number of amino groups per molecule of the compound according to this invention is generally in the range of 100-1,000,000 pieces and preferably in the range of 1,000-100,000 pieces. If the number falls short of 100, the shortage will prevent the compound from fulfilling the cation level, which is considered necessary for a coagulating agent. If the number exceeds 1,000,000, possibly in association with the degree of branch, the excess will increase the proportion of amine contained within the shell regions and yet suffered to be buried therein.

The molecular weight per molecule of the compound according to this invention is generally in the range of 100,000-10,000,000 and preferably in the range of 1,000,000-5,000,000. If the molecular weight falls short of 100,000, the shortage will result in dissatisfying the molecular weight level, which is regarded necessary for a coagulating agent. If the molecular weight exceeds 10,000,000, the excess will render synthesis of a dendrimer difficult where the molecular weight is increased in the core regions. Where the molecular weight is increased in the shell regions, the amount of the amine compound to be added is so large, increases the proportion of amine to be contained in the shell regions and yet suffered to be buried therein.

The core/shell type polyamide dendrimer compound of this invention particularly suits use as a coagulating agent for efficiently removing an anionic component from a solution or a slurry for example as a drainage agent in the field of paper production or as a sludge coagulating agent in the field of waste water disposal. This invention has been initiated by an anxiety about the compound encountering difficulty in the adsorption and removal of an anionic component in the actual use, on account of the structural factor that part of the amino group incorporated in the molecular skeleton is embedded within the polymer molecule. The compound of this invention is intended for the amino group in the molecule to be utilized effectively by causing the amino group to be exposed through the molecular surface as much as possible. The process used for the production of this compound supports an inference that this invention has materialized the molecular design aimed at initially.

The core/shell type polyamine dendrimer compound of this invention is applicable to a wide range of uses in various industrial fields in which the polyamine compounds have been used heretofore. Examples of the use to be found for this compound may include a drainage agent, retention agent, die fixing agent, sizing agent, deinking agent, and pitch controlling agent in the field of paper production; anchor coating agent, adhesive component, and adherence component in the field of adhesives and adherence; adhesion promoter, waterproof property promoter, and pigment dispersing agent in the field of inks and rubbers; die fixing agent, color bleeding inhibitor, glass/carbon fiber grade sizing agent, and deodorizing component in the field of fibers; sludge coagulating agent, chelating agent, microbial cell coagulating agent, deinking agent, ion-exchange resins, and separating film component in the field of waste water disposal; acidic gas adsorbing agent, aldehyde adsorbing agent, and tobacco small adsorbing agent in the field of gas purging; cosmetic components, shampoo rinse hair conditioner components and surface active agents in the field of cosmetic toiletry; dispersing agent, binder, and concrete admixture in the field of ceramic processing; plating components (brightener and smoother), corrosion inhibitor for acid cleaning, primary anti-rust agent, and lubrication promoter in the field of metal processing; coating agent, antistatic agent, and plasticizer in the field of plastic processing; enzyme fixing agent, incubation base, bio-sensor, germfixation carrier, and virus adsorbing agent in the bio-medical field; fluid loss controlling agent, enhanced oil recovering agent, and oil emulsion breaker in the field of oil drilling; solid electrolyte, electroconductivity promoter, and dispersing agent in the field of electronic/optical materials; recording paper sheet components (ink adhesion promoter and waterproof property promoter) in the field of recording materials; and fungicide, anti-fungus agent, antiseptic agent, cloud-proofing agent, and fire extinguishing agent in the field of environment and hygiene.

The core/shell type polyamine dendrimer compound of this invention proves particularly suitable as a sludge coagulating agent in the field of waste water disposal, and as a coagulating agent for efficient removal of an anionic component from a solution or a slurry among other uses enumerated above for example as a drainage agent in the field of paper industry. This invention has been initiated by an anxiety about the compound encountering difficulty in the adsorption and removal of an anionic component in the actual use, on account of the structural factor that part of the amino group incorporated in the molecular skeleton is embedded within the polymer molecule. The compound of this invention is intended for the amino group in the molecule to be utilized effectively by causing the amino group to be exposed through the molecular surface as much as possible. The process used for the production of this compound supports an inference that this invention has materialized the molecular design aimed at initially.

The illustrative graphic displays shown in the drawings represent complete ideal structures. The advantage of this invention resides in obviating the necessity for such degree of perfection as this. This invention attains this advantage so long as an amine compound is fixed at the terminals, at one of the terminals at least, of the molecular chain of a dendrimer compound, preferably in a spatial density of a certain degree. The availability as an anion coagulating agent mentioned in the present chapter is attained by using a polyamine dendrimer compound prepared in accordance with the given method of synthesis. The structure of such a compound does not always conform perfectly with an ideal structure aimed at. The compound has the possibility of assuming a rather lower molecular weight than that of an ideal structure owing to the fracture of molecular chain, assuming a rather higher molecular weight than that of an ideal structure conversely owing to the occurrence of a cross-linking reaction between adjacent molecules, or assuming a rather lower degree of ramification owing to the consumption of a branching agent in other than the main reaction. The method of synthesis which is described in the present specification is not aimed at either forming an ideal structure illustrated for the purpose of illustration or necessitating perfection of a high degree.

### EXAMPLES

This invention will be described more specifically below based on examples thereof. It ought to be noted, however, that this invention is not limited to these examples.

### (Methods of Determination)

Static light scattering method: The molecular weight, M, of the present synthetic dendrimer compound is determined by using water as a solvent to measure and subjecting the measured data to the Zimm or Berry plotting.

Method for determining hydroxylation: To a flask (a flask, and a cap both made of Teflon) exclusively for measuring a hydroxyl value, is placed a sample of the dendrimer compound, pored an acetic anhydride/pyridine solution as an acetylating reagent, and the mixture is heated on a hot plate at 105° C. for 40 minutes with stirring thereby acetylating the hydroxyl group. After hydrolyzing the excess acetic anhydride, which remains in the system, by pouring water into the system, a 0.5N potassium hydroxide as a titrant is set to an automatic titrating device, and potentiometric titration is performed. Similarly, a blank test without the compound is performed. Based on the amounts of titrant spent on the two occasions of titration, the molar amount of carboxylic acid by-produced (equimolarly to the original hydroxyl group) by the acetylation is computed and reduced to the amount of potassium hydroxide, thereby determining the hydroxyl value, HV (mg KOH/g), contained in 1 g. of the present synthetic dendrimer compound. Since the reciprocal of this determined value is equivalent to the molecular weight per hydroxyl group, the molecular weight, M′, of the compound is found by multiplying the reciprocal by the theoretical degree of branch.

GPC method: The molecular weight, M″, of the present synthetic dendrimer compound is determined by performing GPC analysis using Shodex OHpak SB-802HQ, SB-803HQ, SB-804dHQ, and SB-805HQ (available from Showa Denko K.K. in Japan) as columns, water as an eluant, and a straight-chain polyethylene glycol as a reference substance.

Method of nonaqueous titration: A sample of the dendrimer compound, methanol as a solvent and acetic acid as an acidic solvent are added to a beaker, and the resultant is stirred. The resultant solution is set in an automatic titrating device, and nonaqueous titration is performed using a 0.5N p-toluene sulfonic acid/acetic acid solution as a titrant to determine the amine number, AVn, of the present synthetic core/shell type polyamine dendrimer compound.

Method for colloidal titration: A sample of the dendrimer compound is placed in a beaker, and is diluted with water till the amine component reaches a very low concentration of about 20 μg/ml. The pH of the resultant solution is adjusted to 1-2 by adding a proper amount of a 0.1N HCl solution. After several drops of toluidine blue are dropped therein as an indicator, the titration is performed using a 1/400N potassium polyvinyl sulfonate as a titrant. Regarding the point at which the color of the solution changes from blue to purple as the equivalent point, and the amine number, AVc, of the present synthetic core/shall type polyamine dendrimer compound is determined.

Drainage test (Test for ability to filter water): 200 g of white color pages of a boys' comic book and 500 g of water are mixed, manually kneaded, and left standing in a closed state in water for not less than three hours to form a slurry. To the slurry, is added 4000 g of water and the resultant is subjected to the action of a beater for not less than 30 minutes to obtain a slurry of 2% by weight. The pH of the resultant is adjusted to 6-7 by adding acetic acid. 150 g of the slurry and 850 g of water are added in a plastic measuring cylinder, and gently stirring is performed to prepare a testing slurry. To this testing slurry, is added the synthetic core-shell type polyamine dendrimer compound in an amount equivalent to 10 mmols as amine content based on 1 g of paper, gently stirring is performed, then the resultant slurry is poured into a Canadian freeness tester to clock the time, DT_{600/10}, which elapses before the amount of filtered water reaches 600 ml.

### Example 1

Synthesis of star type polyethylene glycol (hereinafter, the polyethylene glycol will be abbreviated as “PEG”) dendrimer derived from terminal polyethylene imine-modified ethylene glycol (hereinafter, the ethylene glycol will be abbreviated as “EG”)

### Example 1-1

### Synthesis of Star Type PEG Dendrimer from EG

### Example 1-1-1

### First Stage of Addition Reaction

A 1 L autoclave with a stirrer was charged with EG (78.3 g, 1.26 mols) and potassium hydroxide (24.0 g) as a catalyst and heated together there with to 150° C. The initially charged liquid in the system was dehydrated by reducing the pressure in the system to 67 hPa and stirring the liquid for one hour. Subsequently, the autoclave was filled to capacity with hyperbaric N₂ to adjust the initial pressure in the system to 49 kPa. Thereafter, glycidyl (93.4 g, 1.26 mols) fed by a HPLC grade pump and ethylene oxide (704.3 g, 15.99 mols) fed under 1.2 MPa back pressure of N₂ were gradually added to the system over a period of 5 hours and they were left reacting at 150±5° C. while the reaction heat was removed. The resultant reaction mixture was left aging for one hour and then cooled to obtain a star burst type PEG dendrimer having three branches and a theoretical molecular weight of about 700 (900 g), wherein the theoretical molecular weight was derived from the calculation based on the charges.

### Example 1-1-2

### Second Stage of Addition Reaction

Subsequently, a 1 L autoclave with the stirrer was charged with the synthetic product of Example 1-1-1 (122.0 g, 0.176 mol) and heated to 150° C. The autoclave was filled to capacity with hyperbaric N₂ till the initial pressure in the system reached 49 kPa. Thereafter, glycidol (91.1 g, 1.23 mols) fed by the HPLC grade pump and ethylene oxide (686.8 g, 15.59 mols) fed under a 1.2 MPa back pressure of N₂ were gradually added over a period of five hours and were left reacting at 150±5° C. while the reaction heat was removed. The resultant reaction mixture was left aging for one hour and then cooled to obtain a star burst type PEG dendrimer having ten branches and a theoretical molecular weight of a bout 5,000 (900 g).

### Example 1-1-3

### Third Stage of Addition Reaction

Subsequently, a 1 L autoclave with the stirrer was charged with the synthetic product of Example 1-1-2 (125.4 g, 24.5 mmols) and heated to 150° C. The autoclave was filled to capacity with hyperbaric N₂ till the initial pressure in the system reached 49 kPa. Thereafter, glycidol (90.7 g, 1.22 mols) fed by the use of the HPLC grade pump and ethylene oxide (683.8 g, 15.52 mols) fed under the 1.2 MPa back pressure of N₂ were gradually added to the autoclave over a period of five hours and left reacting at 150±5° C. while the reaction heat was removed. The resultant reaction mixture was left aging for one hour and cooled to obtain a star burst type PEG dendrimer having 60 branches and a theoretical molecular weight of about 35,000 (900 g).

### Example 1-1-4

### Fourth Stage of Addition Reaction

Subsequently, a 1 L autoclave with the stirrer was charged with the synthetic product of Example 1-1-3 (329.2 g, 8.96 mmols) and potassium hydroxide as an additional portion of catalyst (4.3 g) and heated to 150±5° C. The initially charged liquid of the system was dehydrated by reducing the pressure in the system to 67 hPa and stirring the liquid for one hour. The autoclave was filled to capacity with hyperbaric N₂ till the initial pressure in the system reached 49 kPa. Thereafter, glycidol (66.4 g, 0.896 mol) fed by the use of the HPLC pump and ethylene oxide (500.2 g, 11.36 mols) fed under the 1.2 MPa back pressure of N₂ were gradually added to the system over a period of five hours and left reacting at 150° C. while the heat of reaction was removed. After the reaction mixture was left aging for one hour and then cooled to obtain a star burst type PEG dendrimer having 160 branches and a theoretical molecular weight of about 100,000 (900 g).

### Example 1-1-5

### Fifth Stage of Addition Reaction

Subsequently a 1 L autoclave with the stirrer was charged with the synthetic product of Example 1-1-4 (90.4 g, 0.904 mmol) and heated to 150° C. The auto clave was filled to capacity with hyperbaric N₂ till the initial pressure in the system reached 49 kPa. Thereafter, ethylene oxide (809.6 g, 18.38 mols) fed under the 1.2 MPa back pressure of N₂ was gradually added to the autoclave over a period of five hours and left reacting at 150±5° C. while the reaction heat was removed. The resultant mixture was left aging for one hour and then cooled to obtain a star type PEG dendrimer having 160 branches and a theoretical molecular weight of about 1,000,000 (900 g). The M of the product was found to be 9.18×10⁵, and <S²>^{1/2} to be 347 Å by the static light scattering method. The M/<S²>^{1/2} was consequently found to be 2.7×10³. HV was found to be 9.2 mg KOH/g by the method for determining the hydroxyl value and M′ was consequently found to be 1/(9.2×10⁻³/56.1)×160, hence 9.76×10⁵. M/M′, therefore, was found to be 0.94. M″ was found to be 3.54×10⁵ by the GPC method and M″/M′ was consequently 0.36.

### Example 1-2

### Modification of Terminal Chlorohydrin

In a 1 L separable flask, the synthetic product of Example 1-1-5 (157.7 g, theoretically equivalent to 25.2 mmols of hydroxyl group) was collected and dioxane (617.4 g) as a solvent was added and they were heated to 80° C. and stirred till they formed a homogeneous solution. After the gas in the system was displaced with N₂, the system was sealed with N₂. The homogenous solution and BF₃·OEt₂ (1.6 g, 11.3 mmols) added thereto were mixed by stirring together for 30 minutes. The resultant mixture and a 10% by weight of epichlorohydrin/dioxane solution (23.3 g, epichlorohydrin 25.2 mmols) added gradually thereto over a period of 0.5 hr were left reacting. The reaction mixture was left aging for 3 hours to complete the reaction. As a result of the GC analysis, the added epichlorohydrin had been converted nearly to 100%. Since the by-products thus obtained are added to the solvent initially charged, the reaction solution was found to contain about 82% by weight of dioxane. The dioxane in the reaction solution was removed by transferring this reaction solution to a stirring evaporator, elevating the temperature of the solution to 80° C., and gradually decreasing the pressure in the system to below 27 hPa while keeping the condition of effusion under observation. During the elapse of 1.5 hours thence, the dioxane concentration in the reaction solution was decreased to about 10% by weight. By diluting the concentrated solution (140 g) with distilled water (500 g), an aqueous 20% by weight of star type PEG dendrimer solution (640 g) was obtained.

### Example 1-3

### Modification of Terminal Polyethyleneimine

In a 1 L separable flask, polyethylene imine (12.8 g, available from Nippon Shokubai Co., Ltd. as “Epomin SP-018”) and distilled water (451.2 g) were collected and stirred into a homogeneous aqueous solution. The solution was immediately heated to 80° C. and then the heated solution was left reacting with the synthetic product of Example 1-2 (336.0 g) added gradually thereto over a period of two hours. The resultant reaction mixture was left aging and cooled to obtain an aqueous 10% by weight of star type PEG dendrimer solution (800 g). AVn was found to be 3.07 mmols/g—solid by the nonaqueous titration method. AVc was found to be 3.72 mmols/g—solid by the colloidal titration method. AVn/AVc, therefore, was found to be 0.83. DT_{600/10} was found to be 122 seconds by the drainage test.

### Example 2

### Synthesis of Star Burst Type PEG Dendrimer by the Modification of Terminal Polyethylene Imine in EG

### Example 2-1

### Synthesis of Star Burst Type PEG Dendrimer from EG

### Example 2-1-1

### First Stage of Addition Reaction

The procedure of Example 1-1-1 was repeated, except that EG (78.5 g, 1.26 mols), potassium hydroxide (21.5 g) as a catalyst, glycidol (9.4 g, 0.126 mol), and ethylene oxide (790.7 g, 17.95 mols) were used. Consequently a star burst type PEG dendrimer having about two branches and a theoretical molecular weight of about 700 (900 g) was obtained.

### Example 2-1-2

### Second Stage of Addition Reaction

The procedure of Example 1-1-2 was repeated, except that the synthetic product of Example 2-1-1 (139.2 g, 0.200 mol), glycidol (8.9 g, 0.120 mol), and ethylene oxide (751.9 g, 17.07 mols) were used. Consequently a star burst type PEG dendrimer having about three branches and a theoretical molecular weight of about 4,500 (900 g) was obtained.

### Example 2-1-3

### Third Stage of Addition Reaction

The procedure of Example 1-1-3 was repeated, except that the synthetic product of Example 2-1-2 (127.5 g, 28.4 mmols), glycidol (9.0 g, 0.122 mol), and ethylene oxide (763.4 g, 17.33 mols) were used. Consequently a star burst type PEG dendrimer having seven branches and a theoretical molecular weight of about 32,000 (900 g) was obtained.

### Example 2-1-4

### Fourth Stage of Addition Reaction

The procedure of Example 1-1-4 was repeated, except that the synthetic product of Example 2-1-3 (118.4 g, 3.70 mols), potassium hydroxide as an additional catalyst (1.8 g), glycidol (9.1 g, 0.123 mol), and ethylene oxide (770.7 g, 17.50 mols) were used. Consequently, a star burst type PEG dendrimer having 40 branches and a theoretical molecular weight of about 240,000 (900 g) was obtained.

### Example 2-1-5

### Fifth Stage of Addition Reaction

The procedure of Example 1-1-5 was repeated, except that the synthetic product of Example 2-1-4 (216.8 g, 0.903 mmol), glycidol (8.0 g, 0.108 mol) and ethylene oxide (675.2 g, 15.33 mols) were used. Consequently, a star burst type PEG dendrimer having 160 branches and a theoretical molecular weight of about 1,000,000 (900 g) was obtained. The M was found to be 9.02×10⁵ and <S²>^{1/2} to be 330 Å by the static light scattering method. Consequently, M/<S²>^{1/2} turned out to be 2.7×10³. The HV was found to be 9.2 mg KOH/g by the method for determination of hydroxyl value and M′, therefore, was found to be 1/(9.2×10⁻³/56.1)×160, namely 9.76×10⁵. Consequently, M/M′ turned out to be 0.92. The M″ was found to be 3.45×10⁵ by the GPC method. Thus, M″/M′ turned out to be 0.35.

### Example 2-2

### Synthesis of Star Burst Type PEG Dendrimer by Modification of Terminal Chlorohydrin in EG

The procedure of Example 1-2 was repeated, except that the synthetic product of Example 3-1-5 (157.7 g, theoretically equivalent to 25.2 mmols of hydroxyl group) was used instead of the synthetic product of Example 1-1-5. Consequently, an aqueous 20% by weight of star burst type polypropylene glycol dendrimer solution (800 g) was obtained.

### Example 2-3

### Synthesis of Star Burst Type PEG Dendrimer by the Modification of Terminal Polyethylene Imine in EG

The procedure of Example 1-3 was repeated, except that the syntheticproduct of Example 2-2 (336.0 g) was used instead of the synthetic product of Example 1-2. Consequently an aqueous 10% by weight of star burst type polypropylene glycol dendrimer solution (800 g) was obtained. AVn was found to be 3.14 mmols/g—solid by the nonaqueous titration method. AVc was found to be 3.72 mmols/g—solid by the colloidal titration method. AVn/AVc, therefore, was found to be 0.84. DT_{600/10} was found to be 125 seconds by the drainage test.

### Example 3

### Synthesis of Star Type PEG dendrimer by the Modification of Terminal Polyethylene Imine in Sorbitol

### Example 3-1

### Synthesis of Star Type PEG dendrimer from Sorbitol

Example 3-1-1 The procedure of Example 1-1-1 was repeated, except that sorbitol (hydroxyl number 6 per molecule, 150.5 g, 0.826 mol) in place of EG, potassium hydroxide (21.5 g) as a catalyst, and ethylene oxide (728.0 g, 16.53 mols) were used. Consequently, a star type PEG dendrimer having six branches and a theoretical molecular weight of about 1,000 (900 g) was obtained.

### Example 3-1-2

### Second Stage of Addition Reaction

The procedure of Example 1-1-2 was repeated, except that the synthetic product of Example 3-1-1 (132.3 g, 0.124 mol) and ethylene oxide (767.7 g, 17.43 mols) were used. Consequently, a star burst type polypropylene glycol dendrimer having six branches and a theoretical molecular weight of about 7,000 (900 g) was obtained.

### Example 3-1-3

### Third Stage of Addition Reaction

The procedure of Example 1-1-3 was repeated, except that the synthetic product of Example 3-1-2 (130.1 g, 18.0 mmols) and ethylene oxide (769.9 g, 17.48 mols) were used. Consequently, a star burst type polypropylene glycol dendrimer having six branches and a theoretical molecular weight of about 50,000 (900 g) was obtained. The M was found to be 5.10×10⁴ and <S²>^{1/2} to be 248 A by the static light scattering method. Consequently, M/<S²>^{1/2} was found to be 206. The HV was found to be 6.4 mg KOH/g by the method for determination of hydroxyl value. Consequently, M′ was found to be 1/(6.47×10⁻³/56.1)×6, namely 5.26×10⁴. M/M′, therefore, turned out to be 0.97. The M″ was found to be 4.40×10⁴ by the GPC method. Thus, M″/M′ turned out to be 0.84.

### Example 3-2

### Modification of Terminal Chlorohydrin

The procedure of Example 1-2 was repeated, except that the synthetic product of Example 3-1-3 (158.2 g, theoretically equivalent to 19.0 mols of hydroxyl group) in place of the synthetic product of Example 1-1-5, dioxane (622.6 g), BF₃·OEt₂ (1.6 g), and epichlorohydrin 10% dioxane solution (17.6 g, epichlorohydrin 19.0 mmols) were used. Consequently, an aqueous 20% by weight of star type PEG dendrimer solution (800 g) was obtained.

### Example 3-3

### Cross-Linkage of Modified Terminal Polyethylene Imine

In a 1 L separable flask, the synthetic product of Example 3-2 (598.9 g, theoretically equivalent to 14.2 mols of hydroxyl group) was collected and heated to 80° C. The heated synthetic product was left reacting with ethylene diamine 0.2% dioxane solution (106.8 g, 7.11 mols) which was added gradually thereto over a period of one hour. The resultant reaction mixture was left aging for one hour. Then, the aged reaction mixture and 94.3 g of distilled water added thereto were thoroughly stirred and cooled to obtain an aqueous 15% by weight of cross-linked star type PEG dendrimer solution (800 g).

### Example 3-4

### Modification of Terminal Polyethylene Imine

The procedure of Example 1-3 was repeated, except that the synthetic product of Example 3-3 (448.0 g) in place of the synthetic product of Example 1-2, and distilled water (451.2 g) were used instead. Consequently, an aqueous 10% by weight of star type PEG dendrimer solution (800 g) was obtained. AVn was found to be 3.12 mmols/g—solid by the non aqueoustitration method. AVc was found to be 3.72 mmols/g—solid by the colloidal titration method. Thus, AVn/AVc turned out to be 0.84. DT_{600/10} was found to be 147 seconds by the drainage test.

### Example 4

### Synthesis of Star Type PEG Dendrimer by the Modification of Terminal Polyethylene Imine in Triethylene Tetramine

### Example 4-1

### Synthesis of Star Type PEG Dendrimer from Triethylene Tetramine

### Example 4-1-1

### First Stage of Addition Reaction

The procedure of Example 1-1-1 was repeated, except that triethylene tetramine (the hydroxyl number 6 per molecule, 125.0 g, 0.855 mol) was used instead of EG, potassium hydroxide (22.2 g) as a catalyst, and ethylene oxide (752.8 g, 17.09 mols) were used. Consequently, a star type PEG dendrimer having six branches and a theoretical numerical weight of about 1,000 (900 g) was obtained.

### Example 4-1-2

### Second Stage of Addition Reaction

The procedure of Example 1-1-2 was repeated, except that the synthetic product of Example 4-1-1 (128.5 g, 0.125 mol) and ethylene oxide (771.5 g, 17.51 mols) were used. Consequently, a star type polypropylene glycol dendrimer having six branches and a theoretical molecular weight of about 7,000 (900 g) was obtained.

### Example 4-1-3

### Third Stage of Addition Reaction

The procedure of Example 1-1-3 was repeated, except that the synthetic product of Example 4-1-2 (129.5 g, 18.0 mmols) and ethylene oxide (770.5 g, 17.49 mols) were used. Consequently a star type polypropylene glycol dendrimer having six branches and a theoretical molecular weight of about 50,000 (900 g) was obtained. The M was found to be 4.05×10⁴ and <S²>^{1/2} to be 282 Å by the static light scattering method. HV was found to be 7.6 mg KOH/g by the method for determination of hydroxyl value. Thus, M′ was found to be 1/(7.6×10⁻³/56.1)×6, namely 4.43×10⁴. M/M′, therefore, turned out to be 0.91. The M″ was found to be 3.60×10⁴ by the GPC method. Consequently, M″/M′ turned out to be 0.81.

### Example 4-2

### Modification of Terminal Chlorohydrin

The procedure of Example 1-2 was repeated, except that the synthetic product of Example 3-1-3 (158.2 g, theoretically equivalent to 19.0 mmols of hydroxyl group) in place of the synthetic product of Example 1-1-5, dioxane (622.6 g), BF₃·OEt₂ (1.6 g), and epichlorohydrin 10% dioxane solution (17.6 g, epichlorohydrin 19.0 mols) were used. Consequently, an aqueous 20% by weight of star type PEG dendrimer solution (800 g) was obtained.

### Example 4-3

### Cross-Linkage of Modified Terminal Polyethylene Imine

The procedure of 3-3 was repeated, except that the synthetic product Example 4-2 (598.9 g, theoretically equivalent to 14.2 mmols of chloro group) in place of the synthetic product of Example 3-2, an aqueous 0.2% by weight of ethylene diamine solution (106.8 g, equivalent to 7.11 mmols of ethylene diamine), and distilled water (94.3 g) were used. Consequently, an aqueous 15% by weight of star type PEG dendrimer solution (800 g) was obtained.

### Example 4-4

### Modification of Terminal Polyethylene Imine

The procedure of Example 3-4 was repeated, except that the synthetic product of Example 4-3 (448.0 g) was used instead of the synthetic product of Example 3-3. Consequently, an aqueous 10% by weight of star type PEG dendrimer solution (800 g) was obtained. AVn was found to be 3.10 mmols/g—solid by the nonaqueous titration method. AVc was found to be 3.72 mmols/g—solid by the colloidal titration method. AVn/AVc, thereof, turned out to be 0.83. DT_{600/10} was found to be 150 seconds by the drainage test.

### Example 5

### Synthesis of Star Type PEG Dendrimer by the Modification of Terminal Polyethylene Imine in Ethoxylated Polyethylene Imine

### Example 5-1

### Synthesis of Star Type PEG Dendrimer from Ethoxylated Polyethylene Imine

### Example 5-1-1

### First Stage of Addition Reaction

The procedure of Example 1-1-1 was repeated, except that ethoxylated polyethylene imine (127.8 g, 17.5 mmols, available from Nippon Shokubai Co., Ltd. in Japan as “Epomin KX-PAO-718” (amino group number 42 per molecule)) in place of EG, potassium hydroxide (3.5 g) as a catalyst, and ethylene oxide (768.7 g, 17.5 mols) were used. Consequently, a star type PEG dendrimer having 42 branches and a theoretical molecular weight of about 50,000 (900 g) was obtained.

### Example 5-1-2

### Second Stage of Addition Reaction

The procedure of Example 1-1-2 was repeated, except that the synthetic product of Example 5-1-1 (115.6 g, 2.25 mmols) and ethylene oxide (784.4 g, 17.8 mols) were used. Consequently, a star type polypropylene glycol dendrimer having 42 branches and a theoretical molecular weight of about 400,000 (900 g) was obtained. The M was found to be 3.48×10⁵ and <S²>^{1/2} to be 25 Å by the static light scattering method. M/<S²>^{1/2}, therefore, turned out to be 1.4×10⁴. HV was found to be 5.9 mg KOW/g by the method for determining hydroxyl value. The M′, therefore, was found to be 1/(509×10^{31 3}/56.1)×42, namely 3.99×10⁵. M/M′ consequently turned out to be 0.87. The M″ was found to be 1.22×10⁵by the GPC method. M″/M′, therefore, turned out to be 0.31.

### Example 5-2

### Modification of Terminal Chlorohydrin

The procedure of Example 1-2 was repeated, except that the synthetic product of Example 5-1-3 (158.5 g, theoretically equivalent to 16.7 mmols of hydroxyl group) in place of the synthetic product of Example 1-1-3, dioxane (624.5 g), BF₃·OEt₂ (1.6 g), and epichlorohydrin 10% dioxane solution (15.4 g, epichlorohydrin 16.6 mmols) were used. Consequently, an aqueous 20% by weight of star type PEG dendrimer solution (800 g) was obtained.

### Example 5-3

### Cross-Linkage of Modified Terminal Polyethylene Imine

The procedure of Example 3-3 was repeated, except that the synthetic product of Example 5-2 (599.8 g, theoretically equivalent to 12.5 mmols of chlor group) in place of the synthetic product of Example 3-2, an aqueous 0.1% by weight of ethylene diamine solution (23.4 g, ethylene diamine 1.56 mmols), and distilled water (176.8 g) were used. Consequently, anaqueous 15% by weight of cross-linked star type PEG dendrimer solution (800 g) was obtained.

### Example 5-4

### Modification of Terminal Polyethylene Imine

The procedure of Example 3-4 was repeated, except that the synthetic product of Example 5-3 (168.0 g) was used instead of the synthetic product of Example 3-3. Consequently, an aqueous 10% by weight of star type PEG dendrimer solution (800 g) was obtained. AVn was found to be 3.07 mmols/g—solid by the nonaqueous titration method. AVc was found to be 3.72 mmols/g—solid by the colloidal titration method. AVn/AVc, therefore, turned out to be 0.83. DT_{600/10} was found to be 142 seconds by the drainage test.

### Example 6

### Synthesis of Star Type PEG Dendrimer by the Modification of Terminal Polyethylene Imine in EG

### Example 6-1

### Synthesis of Star Type PEG Dendrimer from EG

### Example 6-1-1

### First Stage of Condensation Reaction

In a 200 ml flask, EG (28.1 g, 0.453 mol) and sodium hydride (21.7 g, 0.906 mol) were collected, heated to 80° C., and left reacting to alkoxidize the opposite terminal hydroxyl groups of EG. Subsequently, the resultant reaction mixture and 3-chloro-1,2-propane diol (100.1 g, 0.906 mol) added thereto were subjected to condensation reaction to prepare a compound having four hydroxyl groups in one molecule (150 g).

### Example 6-1-2

### First Stage of Addition Reaction

In a 1 L autoclave with a stirrer, the synthetic product of Example 6-1-1 (114.3 g, 0.544 mol) and potassium hydroxide (3.8 g) as a catalyst were collected and heated to 120° C. The initially charged liquid in the system was dehydrated by reducing the pressure in the system to 67 hPa and stirring the initially charged liquid for one hour. Subsequently, the autoclave was filled to capacity with hyperbaric N₂ till the initial pressure in the system reached 49 kPa. Thereafter, the resultant reaction mixture and ethylene oxide (781.9 g, 17.8 mols) added gradually thereto under a 1.2 MPa backpressure of N₂ over a period of five hours were left reacting at 120±5° C. while the reaction heat was removed from the system. The reaction mixture consequently formed was left aging for one hour and then cooled to obtain a star type PEG dendrimer having four branches and a theoretical molecular weight of about 1600 (900 g).

### Example 6-1-3

### Second Stage of Condensation/Addition Reaction

Subsequently, a 1 L autoclave with the stirrer, the synthetic product of Example 6-1-2 (293.0 g, 0.178 mol) and sodium hydride (17.1 g, 0.711 mol) were collected, heated to 80° C. and left reacting to alkoxidize the opposite terminal hydroxyl groups of EG. Subsequently, the resultant reaction mixture and 3-chloro-1,2-propane diol (78.6 g, 0.711 mol) added thereto were subjected to condensation reaction to prepare a star type PEG dendrimer having eight hydroxyl groups in one molecule. The auto clave was heated to 120° C. and filled to capacity with hyperbaric N₂ till the initial pressure in the system reached 49 kPa. Thereafter, the reaction mixture and ethyleneoxide (511.3 g, 11.6 mols) added gradually thereto under a 1.2 MPa back pressure of N₂ were left reacting at 120±5° C. while the reaction heat was removed. It was left aging for one hour and then cooled to obtain a star type PEG dendrimer having eight branches and a theoretical molecular weight of about 5,000 (900 g).

### Example 6-1-4

### Third Stage of Condensation/Addition Reaction

The procedure of Example 6-1-3 was repeated, except that the synthetic product of Example 6-1-3 (372.4 g, 77.3 mmols), sodium hydride (14.8 g, 0.618 mol), 3-chloro-1,2-propane diol (68.3 g, 0.618 mol), and ethylene oxide (444.4 g, 10.1 mols) were used. Consequently, a star type PEG dendrimer having about 16 branches and a theoretical molecular weight of about 11,000 (900 g) was obtained.

### Example 6-1-5

### Fourth Stage of Condensation/Addition Reaction

Subsequently, in a 1 L autoclave with the stirrer, the synthetic product of Example 6-1-4 (402.9 g, 36.1 mmols) and sodium hydride (13.9 g, 57.7 mmols) were collected, heated to 80° C., and left reacting to alkoxidize the terminal hydroxyl group. Subsequently, the resultant reaction mixture and 3-chloro-1,2-propane diol (63.8 g, 0.577 mol) added thereto were subjected to condensation reaction to prepare a star type PEG dendrimer having 32 hydroxyl groups in one molecular. The autoclave was heated to 120° C. and filled to capacity with hyperbaric N₂ till the initial pressure in the system reached 49 kPa. Thereafter, the reaction mixture and ethylene oxide (415.1 g, 9.42 mols) gradually added thereto under a 1.2 MPa back pressure of N₂ were left reacting at 120±5° C. while the reaction heat was removed. The resultant reaction product was left aging for one hour and then cooled to obtain a star type PEG dendrimer having 32 branches and a theoretical molecular weight of about 24,000 (900 g).

### Example 6-1-6

### Fifth Stage of Condensation/Addition Reaction

The procedure of Example 6-1-3 was repeated, except that the synthetic product of Example 6-1-5(419.6 g, 17.6 mmols), sodium hydride (13.5 g, 0.563 mol), 3-chloro-1,2-propane diol (62.2 g, 0.563 mol), and ethylene oxide (404.7 g, 9.19 mols) were used. Consequently, a star type PEG dendrimer having 64 branches and a theoretical molecular weight of about 50,000 (900 g) was obtained.

### Example 6-1-7

### Sixth Stage of Condensation/Addition Reaction

The procedure of Example 6-1-3 was repeated, except that the synthetic product of Example 6-1-6 (426.6 g, 8.53 mmols), sodium hydride (13.3 g, 0.555 mol), 3-chloro-1,2-propanediol (61.3 g, 0.555 mol), and ethylene oxide (398.8 g, 9.05 mol) were used. Consequently, a star type PEG dendrimer having 128 branches and a theoretical molecular weight of about 10,000 (900 g) was obtained.

### Example 6-1-8

### Seventh Stage of Addition Reaction

In a 1 L autoclave with the stirrer, the synthetic product of Example 6-1-7 (90.0 g, 0.900 mmols) was collected and heated to 120° C. The initially charged liquid in the system was dehydrated by reducing the pressure in the system to 67 hPa and stirring the charge in the system for one hour. Subsequently, the autoclave was filled to capacity with hyperbaric N₂ till the initial pressure in the system reached 49 kPa. Thereafter, the reaction mixture in the system and ethylene oxide (812.7 g, 18.5 mols) gradually added thereto under a 1.2 MPa back pressure of N₂ over a period of five hours were left reacting at 120±5° C. The reaction product was left aging for one hour and then cooled to obtain a star type PEG dendrimer having 128 branches and a theoretical molecular weight of about 100,000 (900 g). The M was found to be 9.22×10⁵ and <S²>^{1/2} to be 350 Å by the static light scattering method. M/<S²>^{1/2}, therefore, turned out to be 2.6×10³. HV was found to be 9.2 mg KOH/g by the method for determining hydroxyl value. The M′, therefore, was found to be 1/(9.2×10⁻³/56.1)×42, namely 9.76 H10⁵. M/M′, therefore, turned out to be 0.94. The M″ was found to be 3.59×10⁵ by the GPC method. M″/M′, therefore, turned out to be 0.37.

### Example 6-2

### Synthesis of Star Type PEG Dendrimer by the Modification of Terminal Chlorohydrin in EG

The procedure of Example 1-2 was repeated, except that the synthetic product of Example 6-1-8 (158.1 g, theoretically equivalent to 20.2 mmols of hydroxyl group) in place of the synthetic product of Example 1-1-5, dioxane (621.5 g), and epichlorohydrin 10% by weight/dioxane solution (18.7 g, epichlorohydrin 20.2 mmols) were used. Consequently, an aqueous 20% by weight of star type polypropylene glycol dendrimer solution (800 g) was obtained.

### Example 6-3

### Synthesis of Star Burst Type PEG Dendrimer by the Modification of Terminal Polyethylene Imine in EG

The procedure of Example 1-3 was repeated, except that the synthetic product of Example 6-2 (336.0 g, theoretically equivalent to 25.2 mmols of chlor group) was used instead of the synthetic product of Example 1-2. Consequently, an aqueous 10% by weight of star type polypropylene glycol dendrimer solution (800 g) was obtained. AVn was found to be 3.12 mmols/g—solid by the nonaqueous titration method. AVc was found to be 3.72 mmols/g—solid by the colloidal titration method. AVn/AVc, therefore, turned out to be 0.84. DT_{600/10} was found to be 135 seconds by the drainage test.

### Example 7

### Synthesis of Star Type Polypropylene Glycol Dendrimer by the Modification of Terminal Polyethylene Imine in EG

### Example 7-1

### Synthesis of Star Burst Type Polypropylene Glycol Dendrimer from EG

### Example 7-1-1

### First Stage of Addition Reaction

The procedure of Example 1-1-1 was repeated, except that propylene oxide (704.3 g, 12.1 mols) was used instead of ethylene oxide (704.3 g, 16.0 mols). Consequently, a star burst type polypropylene glycol dendrimer having three branches and a theoretical molecular weight of about 700 (900 g) was obtained.

### Example 7-1-2

### Second Stage of Addition Reaction

The procedure of Example 1-1-2 was repeated, except that the synthetic product of example 7-1-1 (122.0 g, 0.176 mol) in place of the synthetic product of Example 1-1-1 and propylene oxide (686.8 g, 11.8 mols) in place of ethylene oxide were used. Consequently, a star type polypropylene glycol dendrimer having ten branches and a theoretical molecular weight of about 5,000 (900 g) was obtained.

### Example 7-1-3

### Third Stage of Addition Reaction

The procedure of Example 1-1-2 was repeated, except that the synthetic product of Example 7-1-2 (125.4 g, 24.5 mmols) in place of the synthetic product of example 1-1-2 and propylene oxide (683.8 g, 11.8 mmols) in place of ethylene oxide were used. Consequently, a star type polypropylene glycol dendrimer having 60 branches and a theoretical molecular weight of about 37,000 (900 g) was obtained.

### Example 7-1-4

### Fourth Stage of Addition Reaction

The procedure of Example 1-1-4 was repeated, except that the synthetic product of Example 7-1-3 (329.2 g, 8.96 mmols) in place of the synthetic product of Example 1-1-3 and propylene oxide (500.2 g, 8.61 mols) in place of ethylene oxide were used. Consequently, a star type polypropylene glycol dendrimer of 160 branches and of a theoretical molecular weight of about 100,000 (900 g) was obtained.

### Example 7-1-5

### Fifth Stage of Addition Reaction

The procedure of example 1-1-5 was repeated, except that the synthetic product of example 7-1-4 (90.4 g, 0.904 mmol) and propylene oxide (809.6 g, 13.9 mols) in place of ethylene oxide were used. Consequently, a star type polypropylene glycol dendrimer having 160 branches and a theoretical molecular weight of about 1,000,000 (900 g) was obtained. The M was found to be 9.12×10⁵ and <S²>^{1/2} to be 360 Å by the static light scattering method. M/<S²>^{1/2}, therefore, turned out to be 2.5×10³. HV was found to be 9.2 mg KOH/g by the method for determining hydroxyl value. The M′, therefore, was found to be 1/(9.2×10⁻³/56.1)×42, namely 9.76×10⁵. M/M′ consequently turned out to be 0.93. The M′ was found to be 3.30×10⁵ by the GPC method. M″/M′, therefore, turned out to be 0.34.

### Example 7-2

### Modification of Terminal Chlorohydrin

The procedure of Example 1-2 was repeated, except that the synthetic product of Example 7-1-5 (157.7 g, theoretically equivalent to 25.2 mmols of hydroxyl group) was used instead of the synthetic product of Example 1-1-5. Consequently, an aqueous 20% by weight of star type polypropylene glycol dendrimer solution (800 g) was obtained.

### Example 7-3

### Modification of Terminal Polyethylene Imine

The procedure of Example 1-3 was repeated, except that the synthetic product of Example 7-2 (336.0 g, theoretically equivalent to 10.6 mmols of chlor group) was used instead of the synthetic product of Example 1-2. Consequently, an aqueous 10% by weight of star type polypropylene glycol dendrimer solution (800 g) was obtained. AVn was found to be 3.06 mmols/g—solid by the nonaqueous titration method. AVc was found to be 3.72 mmols/g—solid by the colloidal titration method. AVn/AVc, therefore, turned out to be 0.83. DT_{600/10} was found to be 122 seconds by the drainage test.

### Example 8

### Synthesis of Star Type PEG Dendrimer of the Modification Terminal Polyethylene Imine in EG

### Example 8-1

### Allyl Modification of Terminal of Star Type PEG Dendrimer from EG

In a 1 L separable flask, the synthetic product of Example 1-1 (157.1 g, theoretically equivalent to 25.1 mmols of hydroxyl group) and dioxane (614.2 g) as a solvent added thereto were heated to 80° C. and stirred till they formed a homogeneous solution. The system was sealed with N₂ after the gas therein had been displaced with N₂. The solution in the system and a 10% by weight of allyl glycidyl ether/dioxane solution (28.7 g, allyl glycidyl ether 25.1 mmols) added gradually thereto over a period of 0.5 hour were left reacting. The reaction product was immediately left aging for three hours to complete the reaction. The dioxanein the reaction solution was removed by transferring the reaction solution to a stirring evaporator, heating it to 80° C., and gradually reducing the pressure in the system to below 27 hPa while keeping the condition of effusion under observation. During the elapse of 1.5 hours, the dioxane concentration in the reaction solution was decreased to about 10% by weight. By diluting the concentrated solution (140 g) with distilled water (500 g), an aqueous 20% by weight of star type PEG dendrimer (800 g) was obtained.

### Example 8-2

### Modification of Terminal Polyethylene Imine

The procedure of Example 1-3 was repeated, except that the synthetic product (336.0 g, theoretically equivalent to 10.6 mmols of chlor group) was used instead of the synthetic product of Example 1-2. Consequently an aqueous 10% by weight of star type PEG dendrimer solution (800 g) was obtained. AVn was found to be 3.09 mmols/g—solid by the nonaqueous titration method. AVc was found to be 3.72 mmols/g—solid by the colloidal titration method. AVn/AVc, therefore, turned out to be 0.83. DT_{600/10} was found to be 124 seconds by the drainage test.

### Example 9

### Synthesis of Star Type PEG Dendrimer by the Modification of Terminal Polyethylene Imine in EG

### Example 9-1

### Chlor Modification of Terminal of Star Type PEG Dendrimer from EG

The procedure of Example 8-1 was repeated, except that the synthetic product of Example 1-1 (157.3 g, theoretically equivalent to 25.2 mmols), dioxane (616.1 g), and 2-chloroethyl isocyanate 10% by weight of dioxane solution (26.6 g, 25.2 mmols) in place of the allyl glycidyl ether 10% by weight of dioxane solution were used. Consequently, an aqueous 20% by weight of star type PEG dendrimer (800 g) was obtained.

### Example 9-2

### Modification of Terminal Polyethylene Imine

The procedure of Example 8-2 was repeated, except that the synthetic product of Example 9-1 (336.0 g, theoretically equivalent to 10.6 mmols of chlor group) was used instead of the synthetic product of Example 8-1. Consequently, an aqueous 10% by weight of star type PEG dendrimer solution (800 g) was obtained. AVn was found to be 3.11 mmols/g—solid by the nonaqueous titration method. AVc was found to be 3.72 mmols/g—solid by the colloidal titration method. AVn/AVc, therefore, turned out to be 0.84. DT_{600/10} was found to be 128 seconds by the drainage test.

### Example 10

### Synthesis of Star Type PEG Dendrimer by the Modification of Terminal Polyethylene Imine in EG

### Example 10-1

### Alkoxy/Allyl Modification of Terminal of Star Type PEG Dendrimer from EG

In a 1 L separable flask, the synthetic product of Example 1-1 (158.1 g, theoretically equivalent to 25.3 mmols of hydroxyl group) collected and dioxane (622.6 g) added thereto as a solvent were heated to 80° C. and stirred till they formed a homogeneous solution. The solution and sodium hydride (95% assay, 0.6 g, 25.3 mmols) added thereto were left reacting to alkoxidize the terminal hydroxyl group. Thereafter, to the reaction product was gradually added allyl chloride 10% by weight of dioxane solution (19.4 g, allyl chloride 25.3 mmols) over a period of 0.5 hour to react. The reaction product was immediately left aging for three hours to complete the reaction. The reaction solution was transferred to a stirring evaporator, the temperature thereof heated to 80° C., and the pressure in the reaction system gradually reduced to remove the dioxane therefrom while keeping the condition of effusion under observation. During the elapse of 1.5 hours, the dioxane concentration in the reaction solution was decreased to about 10% by weight. By diluting the concentrated solution (140 g) with distilled water (500 g), an aqueous 20% by weight of star type PEG dendrimer solution (800 g) was obtained.

### Example 10-3

### Modification of Terminal Polyethylene Imine

The procedure of Example 1-3 was repeated, except that the synthetic product of Example 10-1 (336.0 g, theoretically equivalent to 10.6 mmols of chlor group) was used instead of the synthetic product of Example 1-2. Consequently, an aqueous 10% by weight of star type PEG dendrimer solution (800 g) was obtained. AVn was found to be 3.12 mmols/g—solid by the nonaqueous titration method. AVc was found to be 3.72 mmols/g—solid by the colloidal titration method. AVn/AVc, therefore, turned out to be 0.83. DT_{600/10} was found to be 130 seconds by the drainage test.

### Example 11

### Synthesis of Star Type PEG Dendrimer by the Graft Modification of Terminal Ethylene Imine in EG

### Example 11-1

### Carboxyl Modification of Terminal of Star Type PEG Dendrimer Derived from EG

In a 1 L separable flask, the synthetic product of Example 1-1 (157.4 g, theoretically equivalent to 25.2 mmols of hydroxyl group) collected and dioxane (616.9 g) added thereto as a solvent were heated to 80° C. and stirred till they formed a homogeneous solution. To the solution were gradually added acetic anhydride 10% by weight of dioxane solution (25.7 g, acetic anhydride 25.2 mmols) over a period of 0.5 hour to react. The reaction product was immediately left aging for three hours to complete the reaction. The reaction solution was transferred to a stirring evaporator, the temperature thereof heated to 80° C., and the pressure in the reaction system gradually reduced to below 27 hPa to remove the dioxane therefrom while keeping the condition of effusion under observation. During the elapse of 1.5 hours, the dioxane concentration in the reaction solution was decreased to about 10% by weight. By diluting this concentrated solution (140 g) with distilled water (500 g), an aqueous 20% by weight of star type PEG dendrimer (800 g) was obtained.

### Example 11-2

### Graft Modification of Terminal Ethylene Imine

In a 1 L separable flask, the synthetic product of Example 11-1 (336.0 g, theoretically equivalent to 10.6 mmols of chlor group) and distilled water (336.0 g) were collected and stirred till they formed a homogeneous aqueous solution. The aqueous solution was immediately heated to 80° C. To the resultant solution were gradually added an aqueous 10% by weight of ethylene imine solution (128.0 g) over a period of two hours to react. The reaction product was left aging for one hour and then cooled to obtain an aqueous 10% by weight of star type PEG dendrimer (800 g).

AVn was found to be 3.10 mmols/g—solid by the nonaqueous titration method. AVc was found to be 3.72 mmols/g—solid by the colloidal titration method. AVn/AVc, therefore, turned out to be 0.83. DT_{600/10} was found to be 126 seconds by the drainage test.

### Example 12

### Synthesis of Star Type PEG Dendrimer of the Graft Modification of Terminal Ethylene Imine in EG

### Example 12-1

### Alkoxy/Carboxy Modification of Terminal of Star Type PEG Dendrimer Derived from EG

The procedure of Example 10-1 was repeated, except that the synthetic product of Example 1-1 (157.6 g, theoretically equivalent to 25.2 mmols of hydroxyl group), dioxane (618.6 g), and chloroacetic acid 10% by weight of dioxane solution (23.8 g) in place of allyl chloride 10% by weight of dioxane solution were used. Consequently, an aqueous 10% by weight of star type PEG dendrimer (800 g) was obtained.

### Example 12-2

### Graft Modification of Terminal Ethylene Imine

The procedure of Example 11-3 was repeated except that, the synthetic product of Example 12-1 (336.0 g, theoretically equivalent to 10.6 mmols of chlor group) was used instead of the synthetic product of Example 11-1. Consequently, an aqueous 10% by weight of star type PEG dendrimer (800 g) was obtained. AVn was found to be 3.07 mmols/g—solid by the nonaqueous titration method. AVc was found to be 3.72 mmols/g—solid by the colloidal titration method. AVn/AVc, therefore, turned out to be 0.83. DT_{600/10} was found to be 128 seconds by the drainage test.

### Example 13

### Synthesis of Star Type PEG Dendrimer by the Graft Modification of Terminal Imine Graft in EG

### Example 13-1

### Ammonia Modification of Terminal of Star Type PEG Dendrimer Derived from EG

A reaction tube of stainless steel measuring 3 cm in inside diameter and 200 cm in length was filled with pellets of a previously reduced nickel/copper/chromium mixed catalyst (the molar ratio of nickel:copper:chrome—75:23:2). This reaction tube was heated to 240° C. and kept under an increased pressure of 14.7 MPa. To the test tube, hydrogen, ammonia, and an aqueous solution of 20% synthetic product of Example 1-1 (336.0 g, theoretically equivalent to 10.7 mmols of chlor group) were continuously fed so as to undergo a reaction for effecting ammonia modification of the terminals of the molecular chain. The feed volume of hydrogen was 18 L/hr, that of NH₃ was 2 g/min, and that of the aqueous 20% synthetic product of Example 1-1 was 30 g/min. The reaction solution was transferred to a stirring evaporator, the temperature thereof heated to 150° C., the pressure in the system gradually reduced to below 27 hPa while keeping the condition of effusion under observation, and allowing the conditions to remain intact for 1.5 hours to remove the remaining ammonia dissolved in the aqueous solution produced. The resin concentration in the concentrated solution consequently obtained was 98.2%. By diluting the concentrated solution with a distilled water, an aqueous 20% by weight of star type PEG dendrimer solution (640 g) was obtained.

### Example 13-2

### Graft Modification of Ethylene Imine

The procedure of Example 11-2 was repeated, except that the synthetic product of Example 13-1 (336.0 g, theoretically equivalent to 10.7 mmols of amino group) was used instead the synthetic product of Example 11-1. Consequently, an aqueous 10% by weight of star type PEG dendrimer solution (800 g) was obtained. AVn was found to be 3.40 mmols/g—solid by the nonaqueous titration method. AVc was found to be 4.12 mmols/g—solid by the colloidal titration method. AVn/AVc, therefore, turned out to be 0.83. DT_{600/10} was found to be 132 seconds by the drainage test.

### Example 14

### Synthesis of Star Type PEG Dendrimer of the Graft Modification of Terminal Ammonia/Ethylene Imine in EG

In a 1 L separable flask, distilled water (341.4 g) and an aqueous 25% by weight of ammonia solution (3.6 g, 10.6 mmols) were collected and stirred till they formed an aqueous homogenous solution. The solution and the synthetic product of Example 1-2 (336.0 g, theoretically equivalent to 10.6 mmols of chlor group) added gradually thereto over a period of two hours were left reacting and then aging for one hour. The reaction solution was heated to 80° C. and to the solution were gradually added an aqueous 10% by weight of ethylene imine solution (119.0 g) over a period of two hours to react. The reaction product thus obtained was left aging for one hour and then cooled to obtain an aqueous 10% by weight of star type PEG dendrimer solution (800 g). AVn was found to be 3.37 mmols/g—solid by the nonaqueous titration method. AVc was found to be 4.12 mmols/g—solid by the colloidal titration method. AVn/AVc, therefore, turned out to be 0.82. DT_{600/10} was found to be 135 seconds by the drainage test.

### Example 15

### Synthesis of Star Type PEG Dendrimer of the Modification of Terminal Pentaethylene Hexamine in GE

The procedure of Example 1-3 was repeated, except that pentaethylene hexamine was used instead of polyethylene imine. Consequently, an aqueous 10% by weight of star type PEG dendrimer solution (800 g) was obtained. AVn was found to be 3.88 mmols/g—solid by the nonaqueous titration method. AVc was found to be 4.14 mmols/g—solid by the colloidal titration method. AVn/AVc, therefore, turned out to be 0.94. DT_{600/10} was found to be 152 seconds by the drainage test.

### Example 16

### Synthesis of Star Type PEG Dendrimer of the Modification of Terminal Polyvinyl Amine in EG

The procedure of Example 1-3 was repeated, except that polyvinyl amine was used instead of polyethylene imine. Consequently, an aqueous 10% by weight of star type PEG dendrimer solution (800 g) was obtained. AVn was found to be 3.58 mmols/g—solid by the nonaqueous titration method. AVc was found to be 3.72 mmols/g—solid by the colloidal titration method. AVn/AVc, therefore, turned out to be 0.96. DT_{600/10} was found to be 150 second by the drainage test.

### Example 17

### Synthesis of Star Type PEG Dendrimer of the Modification of Terminal Polyallyl Amine in EG

### Example 17-1

### Synthesis of Star Type PEG Dendrimer Derived from EG

The procedure of Example 1-3 was repeated, except that polyvinyl amine was used instead of polyethylene imine. Consequently, an aqueous 10% by weight of star type PEG dendrimer solution (800 g) was obtained. AVn was found to be 2.66 mmols/solid) by the method of nonaqueous titration. AVc was found to be 2.81 mmols/g—solid by the colloidal titration method. AVn/AVc, therefore, turned out to be 0.95. DT_{600/10} was found to be 148 seconds by the drainage test.

### Comparative Example 1

A test was performed on Polymin SK (polyamide polyamine available from BASF) as a comparative example for the ability to aid in filtering water. Consequently, DT_{600/10} was found to be 157 seconds.

In accordance with this invention, a novel polyamine dendrimer compound of a core/shell structure can be obtained. This compound can be advantageously used in industrial fields as an anion component coagulating agent. The compound of this invention manifests an outstanding ability of coagulation even at a relatively small application rate, as a drainage agent or as a retention agent in the process of paper production.

### INDUSTRIAL APPLICABILITY

The compound of this invention can be advantageously used as an anion component coagulating agent in relevant industrial fields. For example, the compound of this invention can be used as a drainage agent or as a retention agent in the process for paper production.

1. A core/shell type polyamine dendrimer compound comprising core regions formed of a dendrimer compound (D) and shell regions formed by the reaction of said dendrimer compound (I) with an amine compound (A).

2. A compound according to claim 1, wherein said dendrimer compound (I) is a product obtained by causing a dendrimer compound (i) with an active hydrogen to react with a modifying agent for amine reacting terminal functional group (B) with a functional group capable of reacting with the active hydrogen of said dendrimer compound (i) and a separate functional group capable of reacting with the amine compound (A) thereby modifying part and/the whole of the active hydrogen of said dendrimer compound (i).

3. A compound according to claim 1, wherein said amine compound (A) is an alkylene imine or a polyalkylene imine.

4. A compound according to claim 2, wherein said modifying gent (B) is a member selected from the group consisting of epichlorohydrin, allyl glycidyl ether, 2-chloroethyl isocyanate, acetic anhydride, and sodium hydride used in combination with allyl chloride or chloroacetic acid.

5. A compound according to claim 1, wherein the ratio, AVn/AVc is in the range of 0.8-1.0, AVn (unit: mmol/g-solid, amount of amino group in mmols per g of solid) being determined by nonaqueous titration and AVc being determined by colloidal titration.

6. A compound according to claim 1, wherein said dendrimer compound comprises a dendrimer structure formed of a centrally branched portion containing at least one point of branches and straight-chain arm portions connected to the most end of branches and radially extended from the most end of branches to the terminals of molecule, and having at least three arms per molecule-or a cross-linked structure thereof.

7. A compound according to claim 1, wherein said dendrimer compound is obtained by sequentially or simultaneously adding a starting substance formed of a compound with at least one active hydrogen atom in one molecule, a branching agent (C) capable of being modified by a reaction with one active hydrogen atom to a molecular form newly acquiring not less than two active hydrogen atoms, and a chain extending agent (D) capable of growing a molecular chain while retaining at least one active hydrogen atom at the terminal thereof in consequence of continuous addition reaction with the active hydrogen atom.

8. A compound according to claim 7, wherein said branching agent (C) is glycidol.

9. A compound according to claim 7, wherein said chain extending agent (D) is an alkylene oxide.

10. A method for producing a core/shell type polyamine dendrimer compound, which comprises forming core regions by using a dendrimer compound (I) and forming shell regions by causing an amine compound (A) to react with said dendrimer compound (I).

11. A method according to claim 10, wherein said dendrimer compound (I) is a product obtained by causing a dendrimer compound (i) with an active hydrogen to react with a modifying agent for amine reacting terminal functional group (B) with a functional group capable of reacting with the active hydrogen of said dendrimer compound (i) and a separate functional group capable of reacting with the amine compound (A) there bymodifying part and/the whole of the active hydrogen of said dendrimer compound (i).
